(19) United States
(12) Patent Application Publication
(10) Pub. No.: US 2023/0415328 A1
(43) Pub. Date: Dec. 28, 2023

(54) PRODUCTIVITY STATION

(71) Applicant: Toden Industries, LLC, Bellingham, WA (US)

(72) Inventors: David John Marcus Tomassen, Bellingham, WA (US); Chad Richard Douglas, Shoreline, WA (US)

(21) Appl. No.: 18/209,465

(22) Filed: Jun. 13, 2023

Related U.S. Application Data
(60) Provisional application No. 63/351,681, filed on Jun. 13, 2022.

(51) Int. Cl. B25H 1/02; A47B 96/02

(52) U.S. Cl. CPC B25H 1/02; A47B 96/028; A47B 96/021; A47B 2230/0092; A47B 2220/0077

(57) ABSTRACT

A productivity station includes a bracket to anchor to a wall structural member and a workbench. The workbench has a top horizontal panel and a slot defined as an opening into an internal volume below the top horizontal panel, forming a T-slot along the workbench. Methods of manufacture and use of the productivity station are also disclosed.

### CROSS-REFERENCE TO RELATED APPLICATION

This application claims the benefit under 35 U.S.C. § 119(e) of U.S. Provisional Patent Application Ser. No. 63/351,681, filed Jun. 13, 2022, the disclosure of which is hereby incorporated herein in its entirety by this reference.

### TECHNICAL FIELD

The present disclosure generally relates to workbench and shelving systems. In particular, the present disclosure relates to a modular and customizable workbench and shelving system.

### BACKGROUND

Workbenches are common features in residential garages and professional workplaces. Workbenches may be used for a variety of manual labor tasks and projects including carpentry, repair, machining, crafting, and the like. Workbenches may be designed to have a worksurface height appropriate for users to stand while working. Many workbenches are designed to have a worksurface height that is customized for the height of the user. Similarly, the height of the worksurface can be customized based on the type of work intended to be carried out. For example, precision work may call for a relatively higher worksurface, while physical work may call for a lower worksurface.

Workbenches may be designed to have a worksurface depth appropriate for users to stand while working and, in some cases, that is customized for the reach of the user. Similarly, the depth of the worksurface can be customized based on the type of work intended to be carried out. For example, repair work may call for storing items above the work surface within arm's reach, while carpentry may call for easier tool access by hanging from underneath a shelf.

A worker may use a number of tools, chemicals, or paints while using a workbench, which could cause abrasion, cuts, or marks to the workbench surface. Some users may strike workpieces placed on the workbench or secured thereto, such as with a vise. Some workpieces placed on the workbench may be large and heavy. Accordingly, it may be appropriate for workbenches to be made of relatively durable materials and have structural strength sufficient to withstand heavy use.

Shelving is commonly found in garages, workplaces, and elsewhere, including near workbenches, to store tools, parts, materials, recreational products, clothes, daily supplies, and the like. Many workbenches have attached or unattached under-table shelving, which can augment storage space and provide a convenient storage or hanging location for items near the worksurface. In typical applications, under-table shelving may be constrained in length by the table legs or other supports, resulting in the attached or unattached under-table shelving storage length being less than the overall workbench length.

### BRIEF DESCRIPTION OF THE SEVERAL VIEWS OF THE DRAWINGS

FIG. 1 is a simplified perspective view of a workbench and shelving system, in accordance with embodiments of the disclosure;

FIG. 2 is a simplified detail view of brackets for securing the workbench of FIG. 1;

FIG. 3 is a simplified perspective section view of the workbench of FIG. 1;

FIG. 4 is a simplified side section view of the workbench of FIG. 1;

FIG. 5 is a simplified side section view of the workbench and shelves of FIG. 1;

FIG. 6 is a simplified section view of the workbench of FIG. 1;

FIG. 7 is a set of simplified depictions of workbenches and shelves secured to corresponding brackets via T-pins;

FIG. 8 is a simplified underside view of a workbench or shelf, depicting a T-pin in place but not rotated into locking position;

FIG. 9 is a simplified underside view of a workbench or shelf, depicting a T-pin in place and rotated into locking position;

FIG. 10 is a simplified perspective view of a T-pin according to embodiments of the present disclosure;

FIG. 11 is a simplified side view of a T-pin according to embodiments of the present disclosure;

FIG. 12 is a simplified perspective partial view of an extension sleeve for securing two workbench or shelf components together, forming a joint, according to one embodiment of the present disclosure;

FIG. 13 is a simplified detail view of the joint of FIG. 12;

FIG. 14 is a simplified perspective view of a finished end according to one embodiment of the present disclosure;

FIG. 15 is a simplified detail view of the finished end of FIG. 14;

FIG. 16 is a simplified detail view of a wire run cavity according to one embodiment of the present disclosure; and

FIG. 17 is a simplified perspective view of a rod bracket according to one embodiment of the present disclosure.

### DETAILED DESCRIPTION

Illustrative examples of the subject matter claimed below will now be disclosed. In the interest of clarity, not all features of an actual implementation are described in this specification. It will be appreciated that in the development of any such actual implementation, numerous implementation-specific decisions must be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

Embodiments of the present disclosure comprise a system of component parts that affix together to form an extendable productivity station. According to embodiments, a productivity station comprises a workbench and/or one or more shelves. Embodiments of a workbench comprise an essentially flat surface. Embodiments include various types and quantities of modular components that may be assembled in customizable configurations to fit a specific installation space and/or surroundings and the specific requirements and needs of the intended user. For example, the respective lengths, installation heights, and depths of shelf components and/or workbench components can be customized to fit the particular circumstances and/or intended uses of that shelf component and/or workbench component. Further, embodiments of the present disclosure provide attachment points and grooves for lights and/or additional accessories to mount and/or hang underneath the workbench or shelves.

According to embodiments, workstation components including a workbench and/or shelves are fabricated in such a way to provide easy assembly of the modular component parts without puncturing, protruding, or driving hardware through the horizontal surface. In the present disclosure, the term “workstation component” may include and refer to a workbench, a desk, a shelf, or other like components. Assembly of the prefabricated parts can be done with relatively few tools and minimal skill, as such assembly may be accomplished with few measuring, cutting, drilling, and/or finishing processing acts in comparison with a typical workbench and/or shelf assembly.

Drawings presented herein are for illustrative purposes only, and are not meant to be actual views of any particular material, component, structure, apparatus, or system. Variations from the shapes depicted in the drawings as a result, for example, of manufacturing techniques and/or tolerances, are to be expected. Thus, embodiments described herein are not to be construed as being limited to the particular shapes or regions as illustrated, but include deviations in shapes that result, for example, from manufacturing. For example, a region illustrated or described as box-shaped may have rough and/or nonlinear features, and a region illustrated or described as round may include some rough and/or linear features. Moreover, sharp angles that are illustrated may be rounded, and vice versa. Thus, the regions illustrated in the figures are schematic in nature, and their shapes are not intended to illustrate the precise shape of a region and do not limit the scope of the present claims. The drawings are not necessarily to scale. Additionally, elements common between figures may retain the same numerical designation.

As used herein, the singular forms “a,” “an,” and “the” are intended to include the plural forms as well, unless the context clearly indicates otherwise.

As used herein, “and/or” includes any and all combinations of one or more of the associated listed items.

As used herein, spatially relative terms, such as “beneath,” “below,” “lower,” “bottom,” “above,” “upper,” “top,” “front,” “rear,” “left,” “right,” and the like, may be used for ease of description to describe one element's or feature's relationship to another element(s) or feature(s) as illustrated in the figures. Unless otherwise specified, the spatially relative terms are intended to encompass different orientations of the materials in addition to the orientation depicted in the figures. For example, if materials in the figures are inverted, elements described as “below” or “beneath” or “under” or “on bottom of” other elements or features would then be oriented “above” or “on top of” the other elements or features. Thus, the term “below” can encompass both an orientation of above and below, depending on the context in which the term is used, which will be evident to one of ordinary skill in the art. The materials may be otherwise oriented (e.g., rotated 90 degrees, inverted, flipped) and the spatially relative descriptors used herein interpreted accordingly.

As used herein, the terms “vertical,” “longitudinal,” “horizontal,” and “lateral” are in reference to a major plane of a structure and are not necessarily defined by Earth's gravitational field. A “horizontal” or “lateral” direction is a direction that is substantially parallel to the major plane of the structure, while a “vertical” or “longitudinal” direction is a direction that is substantially perpendicular to the major plane of the structure. The major plane of the structure is defined by a surface of the structure having a relatively large area compared to other surfaces of the structure.

As used herein, reference to an element as being “on” or “over” another element means and includes the element being directly on top of, directly adjacent to (e.g., directly laterally adjacent to, directly vertically adjacent to), directly underneath, or in direct contact with the other element. It also includes the element being indirectly on top of, indirectly adjacent to (e.g., indirectly laterally adjacent to, indirectly vertically adjacent to), indirectly underneath, or near the other element, with other elements present therebetween. In contrast, when an element is referred to as being “directly on” or “directly adjacent to” another element, there are no intervening elements present.

As used herein, spatially relative terms, such as “beneath,” “below,” “lower,” “bottom,” “above,” “upper,” “top,” “front,” “rear,” “left,” “right,” and the like, may be used for ease of description to describe one element's or feature's relationship to another element(s) or feature(s) as illustrated in the figures. Unless otherwise specified, the spatially relative terms are intended to encompass different orientations of the materials in addition to the orientation depicted in the figures. For example, if materials in the figures are inverted, elements described as “below” or “beneath” or “under” or “on bottom of” other elements or features would then be oriented “above” or “on top of” the other elements or features. Thus, the term “below” can encompass both an orientation of above and below, depending on the context in which the term is used, which will be evident to one of ordinary skill in the art. The materials may be otherwise oriented (e.g., rotated 90 degrees, inverted, flipped) and the spatially relative descriptors used herein interpreted accordingly.

As used herein, the term “configured” refers to a size, shape, material composition, and arrangement of one or more of at least one structure and at least one apparatus facilitating operation of one or more of the structure and the apparatus in a pre-determined way.

As used herein, features (e.g., regions, materials, structures, devices) described as “neighboring” one another means and includes features of the disclosed identity (or identities) that are located most proximate (e.g., closest to) one another. Additional features (e.g., additional regions, additional materials, additional structures, additional devices) not matching the disclosed identity (or identities) of the “neighboring” features may be disposed between the “neighboring” features. Stated another way, the “neighboring” features may be positioned directly adjacent one another, such that no other feature intervenes between the “neighboring” features; or the “neighboring” features may be positioned indirectly adjacent one another, such that at least one feature having an identity other than that associated with at least one the “neighboring” features is positioned between the “neighboring” features. Accordingly, features described as “vertically neighboring” one another means and includes features of the disclosed identity (or identities) that are located most vertically proximate (e.g., vertically closest to) one another. Moreover, features described as “horizontally neighboring” one another means and includes features of the disclosed identity (or identities) that are located most horizontally proximate (e.g., horizontally closest to) one another.

As used herein, the term “substantially” in reference to a given parameter, property, or condition means and includes to a degree that one of ordinary skill in the art would understand that the given parameter, property, or condition is met with a degree of variance, such as within acceptable tolerances. By way of example, depending on the particular parameter, property, or condition that is substantially met, the parameter, property, or condition may be at least 90.0 percent met, at least 95.0 percent met, at least 99.0 percent met, at least 99.9 percent met, or even 100.0 percent met.

As used herein, “about” or “approximately” in reference to a numerical value for a particular parameter is inclusive of the numerical value and a degree of variance from the numerical value that one of ordinary skill in the art would understand is within acceptable tolerances for the particular parameter. For example, “about” or “approximately” in reference to a numerical value may include additional numerical values within a range of from 90.0 percent to 108.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

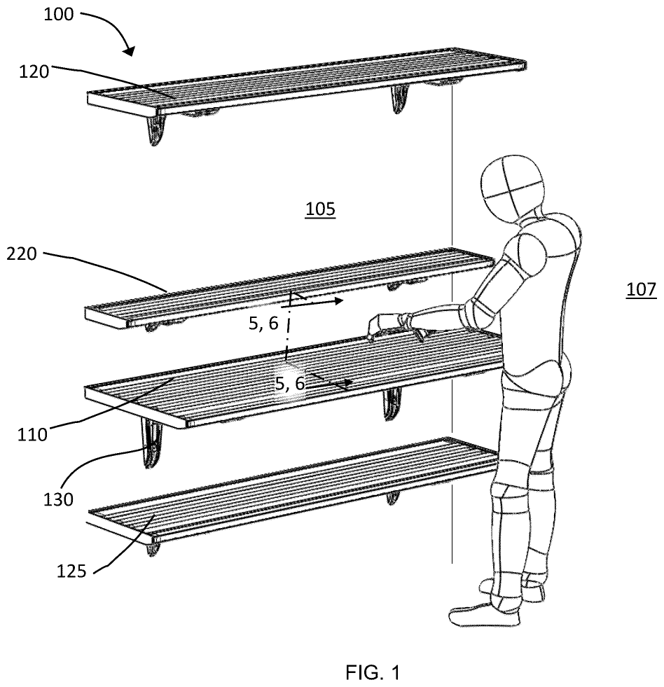

Referring to FIG. 1, embodiments of a productivity station 100 according to the present disclosure comprise wall-mounted workbench 110, first upper shelf 120, second upper shelf 220, and lower shelf 125, which are mounted to brackets 130 affixed to wall 105. According to various embodiments, brackets 130 can be affixed to wall via bolts, screws, or like mounting hardware that secures to wall studs or other structural members of wall 105. In one embodiment, brackets 130 are installed up to approximately 48 inches apart, with the workbench 110 and shelves 120, 220, 125 spanning the distance between neighboring brackets 130.

As shown in FIG. 5, one embodiment of bracket 130 anchors both workbench 110 and shelf 125. In some embodiments, installation is carried out by first affixing connector piece 133 to wall studs or other structural members of wall 105. Embodiments of connector piece 133 comprise one or more pass-through bolt holes (not pictured). One embodiment of connector piece 133 comprises two pass-through bolt holes or slots; one near its upper end, and one near its lower end. The hole near the upper end of the connector piece 133 may be angled, which may increase its load support. In one embodiment, the hole near the upper end of the connector piece 133 has a 10-degree angle relative to the connector piece 133. The connector piece 133 may affix to wall studs or other structural members of the wall 105 by passing a bolt or similar hardware through one or more of its pass-through bolt holes and into the wall studs or other structural members of wall 105. In one example, lag bolts/lag screws are used to secure connector piece 133 to lumber wall studs in wall 105. In other embodiments, other types of hardware are utilized to securely fasten connector piece 133 to wall 105.

Example installations of workbenches and/or shelves of the present disclosure include multiple connector pieces 133, affixed at locations where it is desired to install brackets 130. Some embodiments of brackets 130 include pass-through bolt holes (not depicted) for anchoring a bracket 130 to each connector piece 133, while embodiments of connector pieces 133 include corresponding pass-through bolt holes (not depicted). Brackets 130 can be connected to connector pieces 133 by placing a bracket 130 over each connector piece 133, and may or may not pass a bolt, retaining pin, clip, or other hardware through corresponding pass-through holes on bracket 130 and connector piece 133, and tightening the bolt or other hardware to secure bracket 130 to connector piece 133 for permanent or heavier usage installations. The use of connector pieces 133 as described herein may increase the ease of installation by allowing an installer to measure locations and affix connector pieces 133 without needing to lift heavy components, measure, and/or drill holes at the same time. The use of connector pieces 133 as described herein may allow for easy removal of bracket 130 without tools, removing completely or folding flat against anchored surface when not in use. In some embodiments, brackets 130 are anchored directly to wall studs or other structural members of wall 105 without the use of connector piece 133. Other embodiments have no connector piece 133, but rather involve affixing bracket 130 directly to wall 105 via various types of hardware.

Some embodiments of bracket 130 are configured to secure components 110, 120, 220, 125 of a productivity station. Other embodiments of bracket 130 are configured to anchor only one component of a productivity station. In other words, workbench 110 may be secured to wall 105 via one or more brackets 130 and each shelf may be secured to wall 105 via one or more respective brackets 130.

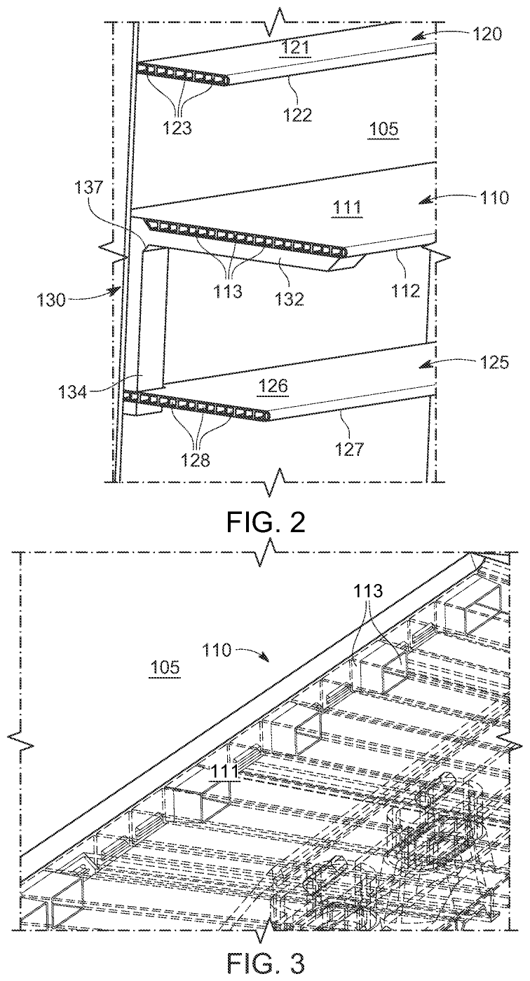

In various embodiments, brackets 130 comprise a set of various shapes, sizes, and configurations. As depicted in FIGS. 1 and 2, one embodiment of bracket 130 comprises a right-angle bracket having a horizontal member 132 and a vertical member 134. Horizontal member 132 is configured to secure to workbench 110 or shelves 120, 220, 125 as will be described in further detail below. Vertical member 134 is configured to attach to wall 105 or other vertical structural member(s). Embodiments are fabricated out of a sufficiently strong material that brackets 130 can be constructed without a triangular brace. Instead, referring to FIG. 5, some embodiments include a small internal corner gusset 138.

One embodiment of the present disclosure has dimensions reflected in FIG. 5, provided as a nonlimiting example. In particular, the embodiment depicted includes a workbench 110 having a depth of 24″ (twenty-four inches) and a thickness of 1″ (one inch), and a bracket 130 with a horizontal member 132 thickness of 1.5″ (one and a half inches). As shown, the tops of horizontal members 132 on bracket 130 are spaced 17″ (seventeen inches) apart, leaving 16″ (sixteen inches) of vertical space between lower shelf 125 and workbench 110. In the example depicted, a storage container having a height of 14″ (fourteen inches) fits on shelf 125 with 0.5″ (one half inch) of vertical space between the top of the storage container and the bottom of bracket 132 above the storage container. It is to be understood that the foregoing dimensions are examples. In other embodiments, it may be desirable to have a narrower workbench or a wider workbench. In other embodiments, it may be desirable to manufacture brackets 132 or other components out of thicker material for added strength or changing bracket 130, lower shelf 125, and workbench 110 dimensions.

According to some embodiments, workbench 110 and shelves 120, 220, 125 have the same length and thickness, only varying in depth, and thus could be interchangeable. In particular, shelves 120, 220, 125 could be used as a work surface, and likewise, workbench 110 could be used as a shelf. Thus, a productivity station could comprise any combination of workbench 110 and/or shelves 120, 220, 125.

Referring to FIGS. 2-4, according to embodiments of the present disclosure, workbench 110 comprises a planar top horizontal panel 111 and a planar bottom horizontal panel 112, with internal ribs 113 between top horizontal panel 111 and bottom horizontal panel 112. In embodiments, each upper shelf 120, 220 respectively comprises a planar top horizontal upper shelf panel 121 and a planar bottom horizontal upper shelf panel 122, with internal ribs 123 between top horizontal upper shelf panel 121 and bottom horizontal upper shelf panel 122. In embodiments, lower shelf 125 comprises a planar top horizontal lower shelf panel 126 and a planar bottom horizontal lower shelf panel 127, with internal ribs 128 between top horizontal lower shelf panel 126 and bottom horizontal lower shelf panel 127.

Some embodiments of workbench 110 and/or shelves 120, 220, 125 comprise a top horizontal panel 111, 121, or 126 but no bottom horizontal panel 112, 122, or 127. In such examples, the internal volume of workbench 110 and/or shelves 120, 220, 125 is open underneath workbench 110 and/or shelves 120, 220, 125. In such embodiments, ribs 113 123, or 128 are thus visible from below workbench 110 and/or shelves 120, 220, 125. In some embodiments, the workbench 110 and/or shelves 120, 220, 125 comprise a top horizontal panel 111, 121, or 126, a bottom horizontal panel 112, 122, or 127, and/or a substantially solid core therebetween.

In embodiments, the internal ribs 113, 123, 128 run along the length of each workbench 110 and shelf 120, 220, 125 (not pictured), making ribs 113, 123, 128 perpendicular to horizontal members 132. According to some embodiments, ribs 113, 123, 128 comprise vertical ridges parallel to wall 105 to which workbench 110 and/or shelves 120, 220, 125 are affixed. In other embodiments, ribs 113, 123, 128, comprise reinforcement corrugations or gussets within the internal volume of workbench 110 or shelf 120, 220, 125. In some embodiments, ribs 113, 123, 128, when viewed from a plan cutaway view, form a grid pattern within the internal volume of workbench 110 or shelf 120, 220, 125. In other embodiments, ribs 113, 123, 128, when viewed from a plan cutaway view, form diagonal or other angles with respect to each other and/or with respect to edges of workbench 110 or shelf 120, 220, 125. Some embodiments comprise solid internal volumes rather than internal ribs. Other embodiments comprise a combination of solid internal volumes and internal ribs. FIG. 3 depicts an embodiment of workbench 110, with the depiction having a translucent top horizontal panel 111 for the purpose of illustration.

Some embodiments of workbench 110 and shelves 120, 220, 125 comprise a flexible edge 119, which comprises a strip of malleable material that seals against the wall 105 as workbench 110 or shelf 120, 220, 125 is pressed against the surface thereof, thus providing an aesthetically uniform interface between the workbench 110 or shelves 120, 220, 125 therebetween. The flexible edge 119 may further provide a seamless, or near-seamless, interface between the workbench 110 or shelves 120, 220, 125 and the surface of the wall 105. As such, the flexible edge 119 may provide spill-resistance and debris collection resistance to the workbench 110 or shelves 120, 220, 125. Additionally, the flexible edge 119 may provide for relatively easy cleaning at the interface between the workbench 110 or shelves 120, 220, 125 and the surface of the wall 105. The flexible edge 119 may be removably installed on the workbench 110 or shelves 120, 220, 125 by insertion of the flexible edge 119 into a groove along the length of the workbench 110 or shelves 120, 220, 125. As such, the flexible edge 119 may be attached to the workbench 110 and shelves 120, 220, 125 and/or removed from the workbench 110 and shelves 120, 220, 125 by the user (e.g., without the use of tools) as a preferred customization by the user. The flexible edge 119 may be selected to be sized (e.g., having a horizontal width extending from the workbench 110 or shelves 120, 220, 125 to which it is attached) as desired. The flexible edge 119 may comprises a flat strip or a rounded strip. The flexible edge 119 may be manufactured by a variety of conventional manufacturing techniques. In one embodiment, the flexible edge 119 is manufactured by an injection molding process, reaction injection molding process, or an extrusion process.

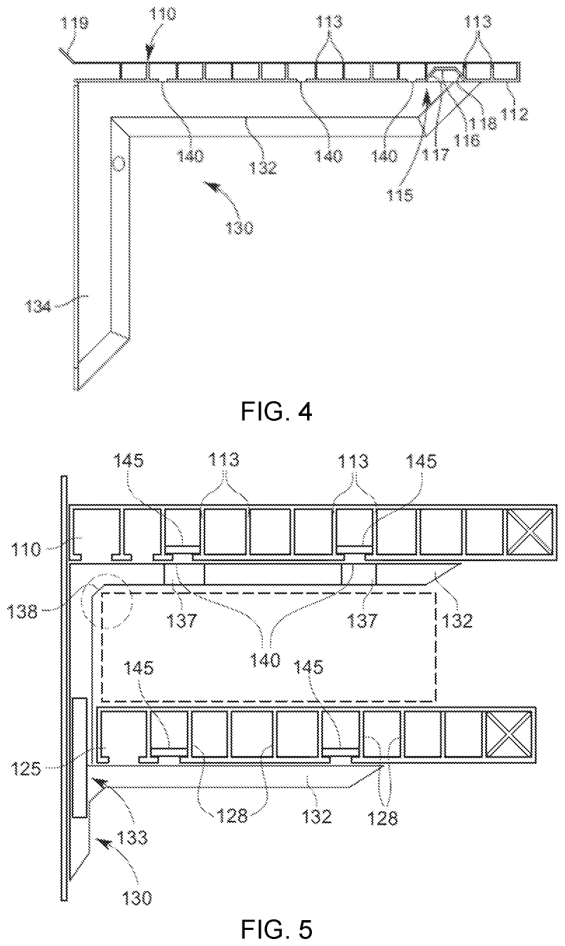

Referring to FIG. 4, embodiments of the present disclosure may comprise LED light groove 115. LED light groove 115 may comprise three surfaces: downward-facing surface 116, forward facing angled surface 117, and rearward facing angled surface 118. In some embodiments, an LED strip light, for example a self-adhesive LED strip light, can be installed within LED light groove 115. An LED strip light may also be known in the art as also known as LED tape or an LED ribbon light and comprises multiple surface-mounted LEDs on a flexible circuit board. By adhering an LED strip light to selected one or more surfaces 116, 117, and/or 118, the user can customize how light can be cast on workbench 110, shelf 125, or other surfaces below LED light groove 115. The position of the LED strip light on one or more surfaces 116, 117, and/or 118 may provide a convenient light source that does not hang below the underside of the workbench 110 or shelf 120, 220, 125 to which it is attached. Further, the position of the LED strip light may allow it to not interfere with bracket connections (e.g., brackets 130) and/or not be damaged by storage containers, etc. placed on the workbench 110 or shelf 120, 220, 125 below the LED strip light. For example, if it is desirable to cast light in a downward direction from LED light groove 115, an LED strip light can be adhered to downward-facing surface 116. If it is desirable to cast light that is angled rearward, i.e., toward wall 105 (e.g., lighting a commercial display), an LED strip light can be adhered to rearward facing angled surface 118. If it is desirable to cast light that is angled forward (e.g., lighting the ground in front of the workbench 110 or shelf 120, 220, 125), an LED strip light can be adhered to forward facing angled surface 117. In other cases, it may be desirable to install a channel for LED strip lights, which may also be known as an “LED extrusion,” “LED profile,” or “LED strip diffuser,” onto one or more of surfaces 116, 117, and/or 118. An LED strip light may then be installed into the channel. The position of such an LED extrusion installed at one or more surfaces 116, 117, and/or 118 may allow it to not interfere with bracket connections (e.g., brackets 130) and/or not be damaged by storage containers, etc. placed on the workbench 110 or shelf 120, 220, 125 below the LED extrusion.

In one embodiment, T-slots 140 comprise lateral slots on the respective bottom panel 112, 122, 127 of each workbench 110 and shelf 120, 220, 125, the T-slots 140 coinciding with internal volumes between selected neighboring internal ribs 113, 123, 128. In embodiments, each T-slot 140 is between two neighboring internal ribs 113, 123, 128. In the embodiment depicted in FIGS. 4 and 5, each lateral slot that forms T-slots 140 is narrower than the distance between neighboring internal ribs 113, 123, 128; the flange on each side of the lateral slots forms a side of the T-slots. In some embodiments in which the workbench 110 and/or shelves 120, 220, 125 comprise a substantially solid core, T-slots 140 may comprise lateral slots on the respective bottom panel 112, 122, 127 of each workbench 110 and shelf 120, 220, 125 and/or on the core of the workbench 110 and/or shelves 120, 220, 125. Downward-facing T-slots 140 can be used for mounting and/or hanging objects and various attachments to the underside of workbench 110 and shelves 120, 220, 125. According to embodiments, T-slots 140 can provide near-infinite positioning of such mounting and/or hanging objects or attachments across the horizontal span of the respective workbench 110 or shelf 120, 220, 125. Due to not being permanently fastened, T-slots 140 may further provide easy and convenient subsequent repositioning at any time.

According to various embodiments, workbench 110 and/or shelves 120, 220, 125 are secured to wall 105 via mounting fixtures. In some embodiments, such mounting fixtures comprises brackets 130, mounting plates 145, and/or other associated hardware such as bolts, nuts, screws, T-Pin 610, and the like. In other embodiments, a mounting fixture comprises hardware to attach workbench 110 and/or shelves 120, 220, 125 directly to wall 105 or 107. In embodiments, workbench 110 and/or shelves 120, 220, 125 can be anchored to respective brackets 130 by inserting mounting plates 145 or similar hardware into T-slots 140, placing the workbench 110 or shelves 120, 220, 125 on a bracket 130, passing bolts or other hardware through the mounting plates and into brackets 130, and tightening the bolts. In embodiments, said bolts can prevent or minimize workbench 110 from lifting as the user works on workpieces on workbench 110. Other embodiments have no mounting plates 145, but rather involve affixing workbench 110 and/or shelves 120, 220, 125 to bracket 130 via T-pins 610 or other hardware. In some embodiments, brackets 130 may be mounted directly to wall 105 by way of T-pins 610, which may prevent and/or minimize workbench 110 from lifting as the user works on workpieces on workbench 110.

According to embodiments, T-slots 140 provide further customization. Accessories, hooks, lights, tools, trays, and other implements as may be desired can be secured to T-slots 140 below workbench 110 or shelf 120, 220, 125. Thus, embodiments of the present disclosure can allow easy positioning in multiple directions of components without measuring, drilling, cutting, acts to form additional supports, or finishing work being conducted by the installer or user.

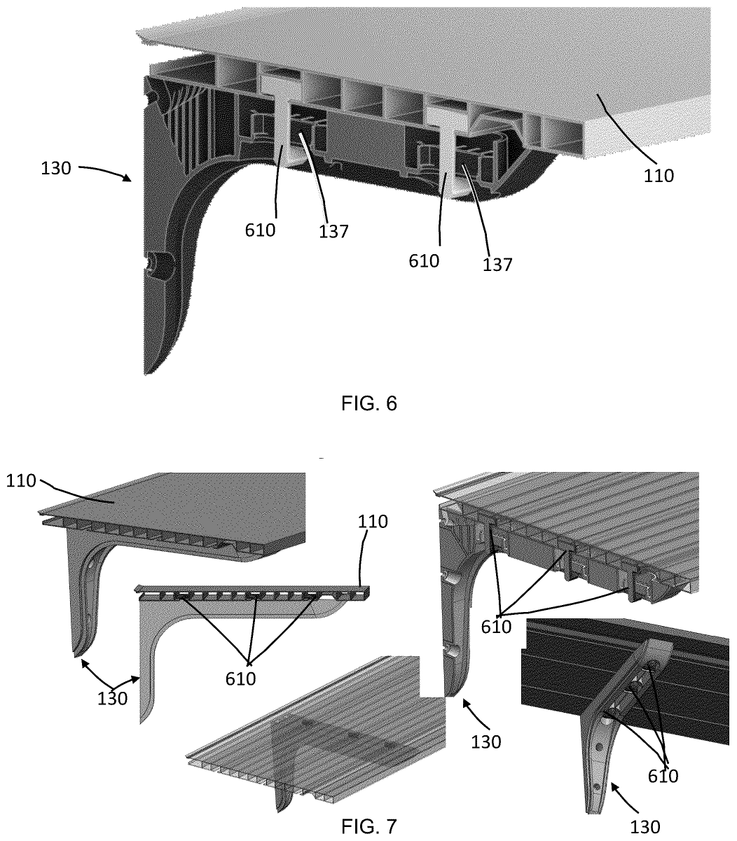

FIG. 6 depicts a sectional view of workbench bracket 130. Grooves 137 in brackets 130 provide forward/rearward movement of workbench 110 (or shelf 120, 220, 125) relative to bracket 130 while workbench 110 or shelf 120, 220, 125 is not secured to bracket 130. T-pins 610 can secure workbench 110 or shelf 120, 220, 125 to bracket 130. In embodiments, multiple T-pins 610 secure workbench 110 or shelf 120, 220, 125 to each bracket 130. FIG. 7 illustrates how workbench 110 or shelves 120, 220, 125 can be secured to bracket 130.

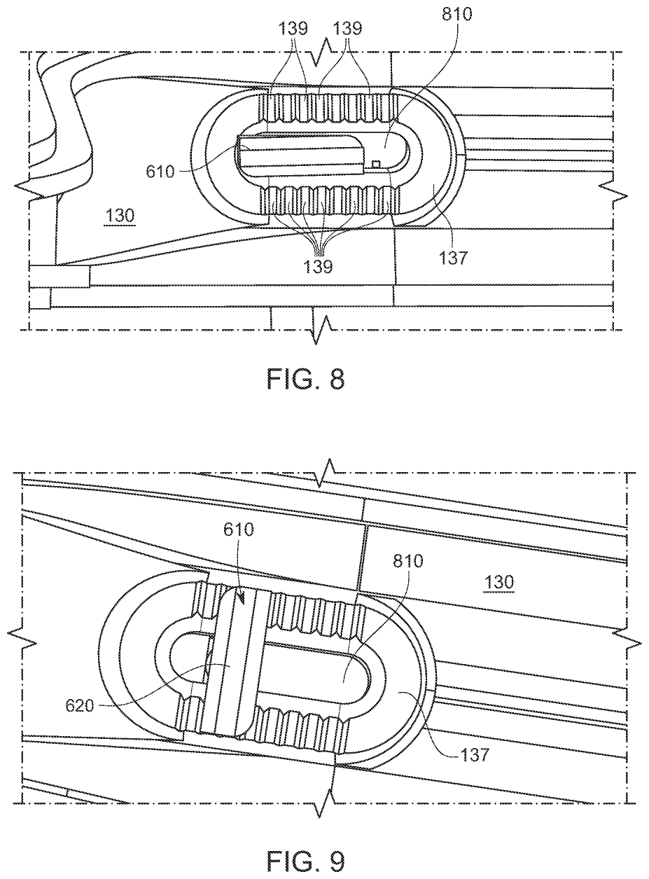

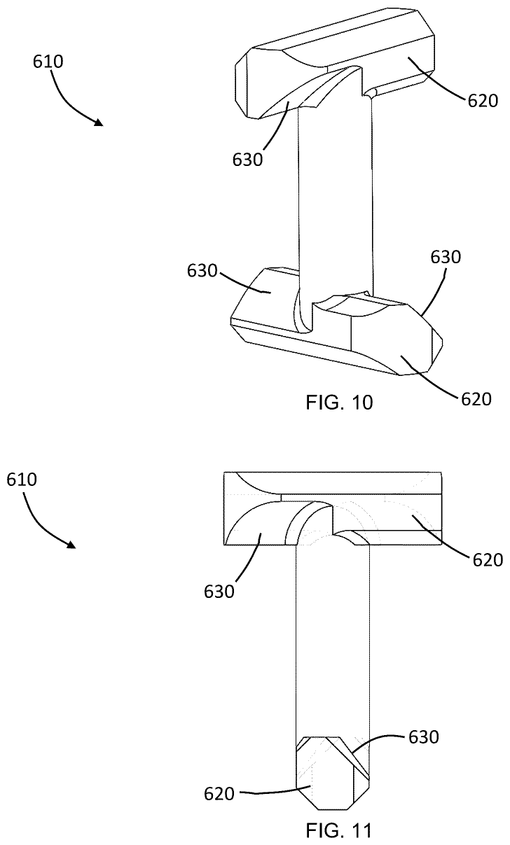

Referring to FIGS. 8 and 9, according to some embodiments of the present disclosure, T-pins 610 lock in place within groove 137 of bracket 130, thereby securing workbench 110 or shelf 120, 220, 125 in place on bracket 130. T-pins 610 pass through bracket slot 810 on bracket 130 and into T-slot 140 of workbench 110 or shelf 120, 220, 125. Once positioned in bracket slot 810 and T-slot 140, T-pin 610 can be rotated approximately ninety degrees to lock in place. As T-pin 610 is rotated, T-pin head 620 interfaces with downward-facing teeth 139 on bracket 130, thereby ratcheting T-pin 610 in place by interactions between teeth 139 and T-pin head 620. Referring to FIGS. 10 and 11, one embodiment of T-pin 610 comprises ramps 630. As T-pin 610 is twisted relative to bracket 130, ramps 630 apply tension to T-pin 610 between workbench 110 or shelf 120, 220, 125 and brackets 131, thereby bringing workbench 110 or shelf 120, 220, 125 and brackets 131 together and securing workbench 110 or shelf 120, 220 in place, which may prevent and/or minimize workbench 110 or shelf 120, 220, 125 from lifting as the user works on workpieces thereon.

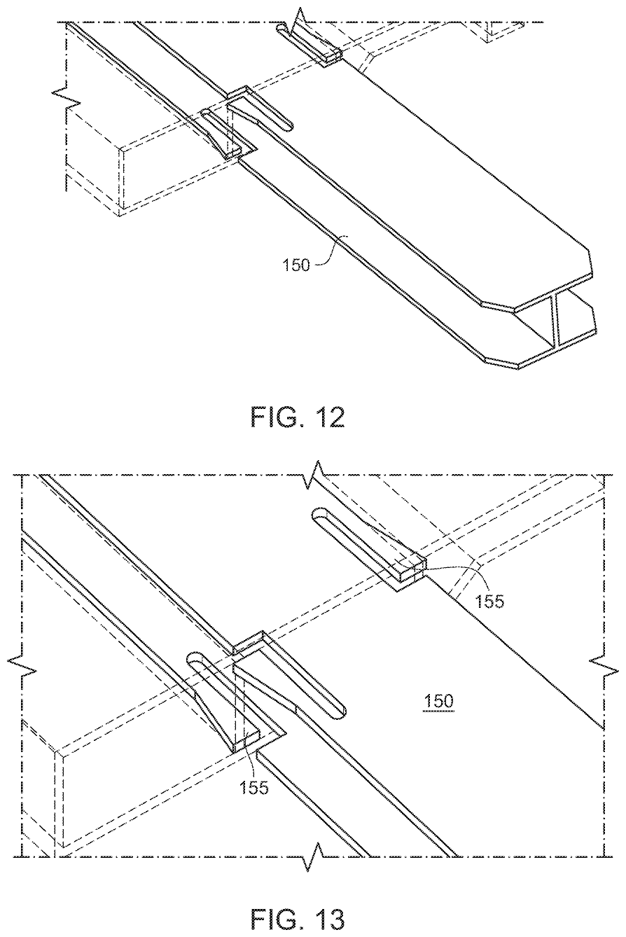

Referring to FIGS. 12 and 13, when it is desired to extend the length of workbench 110 or shelf 120, 220, 125, extension sleeve 150 can be inserted into a space between neighboring internal ribs of one workbench 110 or shelf 120, 220, 125 until stop pins 155 prevent further insertion, and then a second workbench 110 or shelf 120, 220, 125 can be adjoined to the first by inserting the opposite end of extension sleeve 150 into a corresponding space between neighboring internal ribs of the second workbench 110 or shelf 120, 220, 125 until the surfaces have abutted against each other without the use of tools or fasteners. Multiple extension sleeves 150 may be thus inserted into multiple internal ribs for two adjoining workbenches 110 or shelves 120, 220, 125 to maximize load capability of the surfaces. The lengths of worksurfaces and/or shelving may thus be extended and customized without measuring, drilling, cutting, or finishing work being carried out by the installer or user. According to embodiments, extension sleeve 150 comprises an “I-beam” shape, which may enhance its strength and rigidity and limit component weight. The extension sleeve 150 may also be placed in an area within the workbench 110 and/or shelf 120, 220, 125 to increase its stiffness or strength as preferred by an installer or user. By way of nonlimiting example, one or more extension sleeves may be inserted into a space of a workbench 110 or shelf 120, 220, 125 under a vise.

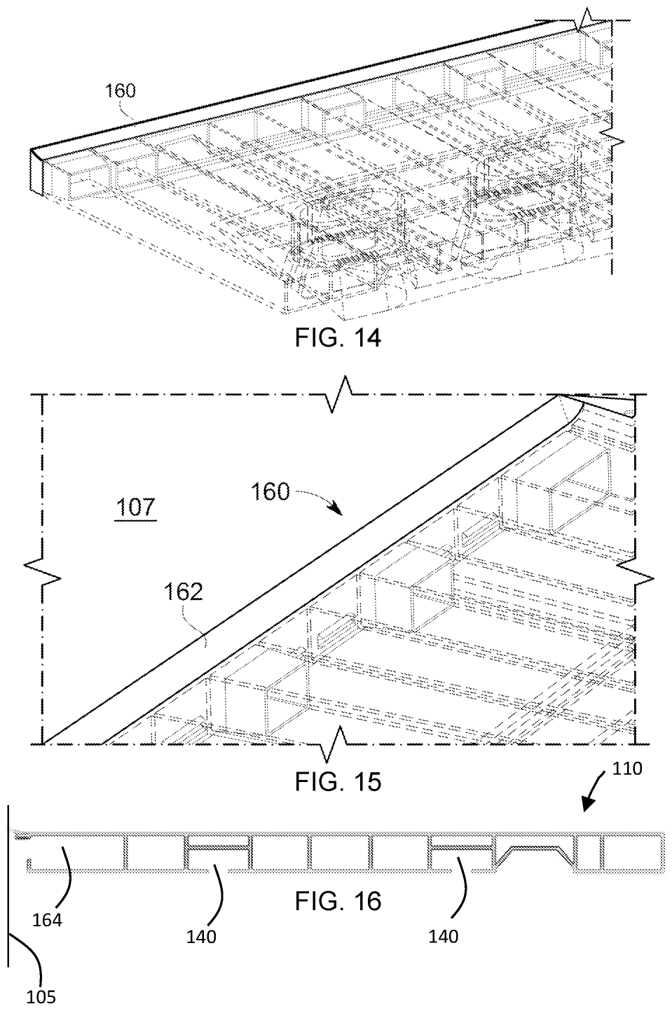

Referring to FIGS. 14 and 15, some embodiments of the present disclosure comprise a finished end 160. Embodiments of finished end 160 provide a structural mounting point in a corner without the use of a bracket 130. According to some embodiments, finished end 160 can be affixed to wall studs or other structural members of a side wall 107 that forms a corner intersection with wall 105, in which case finished end 160 being anchored to wall 107 may provide sufficient structural support itself, without a structural bracket member attached to wall 105 to an end of workbench 110 or shelf 120, 220, 125. A customizable drill pattern may assist the installer to affix finished end 160 at the appropriate vertical and horizonal placement. Thereafter, workbench 110 or shelf 120, 220, 125 may be mated with finished end 160 by sliding toward the finished end 160 until internal ribs of the workbench 110 or shelf 120, 220, 125 mate with matching rectangular structures on finished end 160 via friction fit. Referring to FIG. 10, flexible edge 162 along the edge of finished end 160 seals against corner wall 107 and at corner 109, which may minimize collection of debris, allow for spill resistance, and making cleaning easier. A finished end 160 may also be drilled and mounted to the workbench 110 or shelf 120, 220, 125 to create a corner (e.g., a 90-degree corner) between adjacent workbenches 110 or shelves 120, 220, 125.

Some embodiments of finished end 160 are configured to secure to components 110, 120, 220, 125 of a productivity station. Other embodiments of finished end 160 are configured to anchor only one component of a productivity station. In other words, workbench 110 may be secured to wall 107 via one or more finished ends 160 and each shelf may be secured to wall 107 via one or more respective finished ends 160.

In some embodiments, finished end 160 can be secured to a free-hanging portion of workbench 110 and/or shelf 120, 220, 125; in order words, to a workbench 110 or shelf 120, 220, 125 that is not abutted against a wall (such as at a wall corner). When not affixed to a wall, finished end 160 can provide spill resistance due to flexible edge 162, and a mount on which the user can hang hooks and other hardware to provide additional storage and customization on the end of the workbench 110 and/or shelf 120, 220, 125.

In one embodiment of the present disclosure, workbench 110, shelf 120, 220, 125, bracket 130, extension sleeve 150, and/or finished end 160 are manufactured from a durable, rigid, and sufficiently strong polymer material. In some embodiments, the polymer material comprises a recycled polymer material. In embodiments, the material of manufacture of one or more components 110, 120, 125, 130, 150, and/or 160 comprises post-consumer recycled content. In some embodiments, the material of manufacture includes at least 10% post-consumer or post-industrial recycled content. In some embodiments, the material of manufacture comprises a thermoplastic polymer with fiberglass or carbon fiber reinforcement. According to some embodiments, the material of manufacture comprises thermoplastics, polyester, polyurethane, vinylester, epoxy, methacrylate resin, polyester resin, bio resin, or combinations thereof. In some embodiments, the material of manufacture includes glass fiber reinforcement. In some embodiments, the material of manufacture includes from approximately 20% to approximately 70% glass fiber reinforcement. In one embodiment, the material of manufacture includes approximately 45% glass fiber reinforcement. In various embodiments, the material of manufacture comprises between 0% and 100% post-consumer recycled content. In other embodiments, a sufficiently strong polymer material is one that can be formed into one or more components 110, 120, 220, 125, 130, 150, and/or 160 that are strong enough to withstand the uses set forth throughout the present disclosure or other uses that might be anticipated in light of the present disclosure. Further, some embodiments of the present disclosure comprise a material of manufacture that is sufficiently lightweight such that one or more components 110, 120, 220, 125, 130, 150, and/or 160 can be installed by a single person without additional machinery or equipment.

According to embodiments, workbench 110, and shelves 120, 220, 125 are manufactured by an injection molding process, a reaction injection molding process, an extrusion process, a pultrusion process, an additive manufacturing process and/or other conventional manufacturing techniques. In some embodiments, one or more of workbench 110, shelf 120, 220, 125, bracket 130, extension sleeve 150, and finished end 160 may be made using an injection molding process, a reaction injection molding process, an extrusion process, a pultrusion process, an additive manufacturing process and/or other conventional manufacturing techniques. In other embodiments, alternate manufacturing methods are carried out to manufacture each component. According to some embodiments, a wood slab, granite slab, or other type of slab may be mounted to the top surface of workbench 110 and/or shelves 120, 220, 125 or directly on bracket 130 using various fastening methods, including adhesives. In some embodiments, different colors and/or surface patterns may be imprinted on components 110, 120, 220, 125, 130, 150, and/or 160. In one embodiment, a surface pattern imitating wood, stone grains, dimensional line references and/or texture is replicated on components 110, 120, 220, 125, 130, 150, and/or 160.

In some embodiments, accessory hooks and additional fixtures may be attached to attachment points or T-slot 140 on workbench 110, shelves 120, 220, or 125, bracket 130, and/or finished end 160. Such accessory hooks or fixtures may extend the utility of a productivity station. In some embodiments, such accessory hooks or fixtures may include hooks to hang extension cords, fixtures for supporting clothing hangers and/or closet rods, hooks for hanging bicycles, vertical spacers (or offsets) for a miter saw or other implement that may be benefited by being mounted at a level below the worksurface, mounting locations for shop light fixtures, tool holder drill sleeves, parts bins, paper towel holders, holders for garden tools, shoe/boot shelves, garden hose racks, golf club bag hooks, screwdriver holders, cupholders, ladder hooks or channels, battery charger mounts, bins for fasteners, slide-out baskets, and/or tool/wire baskets. Accordingly, embodiments of the present disclosure may be utilized in a number of types of placements. For example, embodiments can be used as a closet organization system, art table, crafts table, desk, etc.

Referring to FIG. 16, some embodiment of workbench 110 and/or shelves 120, 220, 125 may comprise a dedicated wire run cavity 164 for storage of electrical wires. The wire run cavity 164 may be horizontally offset from the wall 105. The wire run cavity 164 may allow users to supply electrical power to various locations along the workbench 110 and/or shelves 120, 220, 125 without having cords affixed to the bottom of the workbench 110 and shelves 120, 220, 125 or otherwise interfering with mounting hardware, workbench 110, and shelves 120, 220, 125 to bracket 130.

According to some embodiments of the present disclosure, workbench 110 and/or shelves 120, 220, 125 can be installed with less measuring, cutting, and/or drilling in comparison to other workbenches and shelf assemblies. As such, an installer can assemble productivity stations with only a few common tools and by lifting relatively light-weight components into place. Due to the ease of install, installation could be accomplished even by a person having limited physical abilities, such as a person bound to a wheelchair.

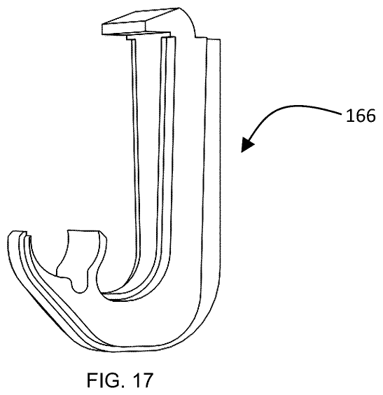

Various attachments and accessories may augment the functionality of the workbench 110 and/or shelves 120, 220, 125. As a nonlimiting example, FIG. 17 depicts a simplified view of a rod bracket 166. Multiple rod brackets 166 may be inserted into a T-slot 140 of a workbench 110 and/or shelf 120, 220, 125. A user may then place a rod into the rod brackets 166 and hang items (e.g., clothing) therefrom.

Various embodiments of the present disclosure not only present an ease of installation but can be quickly and easily disassembled relative to standard workbenches and shelves. A workbench and/or shelf assembly may be disassembled by loosening any bolts followed by removing installed components that had been affixed to wall 105 or 107. This ease of disassembly may be beneficial for home rentals, office spaces, active construction areas, or other locations where a permanent installation may not be desirable.

This concludes the detailed description. The particular examples disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular examples disclosed above may be altered or modified and all such variations are considered within the scope and spirit of the invention. Accordingly, the protection sought herein is as set forth in the claims below.

What is claimed is:

1. A productivity station, comprising:
a bracket configured to anchor to a structural member; and
a workstation component attached to the bracket, the workstation component comprising:
a top horizontal panel; and
a slot defined as an opening into an internal volume below the top horizontal panel, forming a first T-slot along the workstation component.

2. The productivity station of claim 1, wherein the workstation component comprises a workbench, the productivity station further comprising an upper shelf above the workbench, the upper shelf comprising:
a top horizontal upper shelf panel; and
multiple ribs below the top horizontal upper shelf panel, the ribs comprising vertical ridges along a length of the upper shelf.

3. The productivity station of claim 2, wherein the upper shelf further comprises a downward-facing LED light groove.

4. The productivity station of claim 2, wherein the upper shelf further comprises a downward-facing second T-slot.

5. The productivity station of claim 1, wherein the workstation component further comprises a bottom horizontal panel.

6. The productivity station of claim 1, further comprising a lower shelf below the workstation component.

7. The productivity station of claim 6, wherein the lower shelf further comprises a downward-facing third T-slot:

8. The productivity station of claim 6, wherein the lower shelf further comprises a downward-facing LED light groove.

9. The productivity station of claim 1, wherein the bracket is configured to anchor to the wall structural member by being affixed to a connector piece anchored to the wall structural member.

10. The productivity station of claim 1, further comprising a T-pin in the first T-slot, the T-pin configured to secure the workstation component to the bracket.

11. The productivity station of claim 1, wherein the bracket and the workstation component are formed of a material selected from the group consisting of a thermoplastic, a polyester, a polyurethane, a vinylester, an epoxy, a methacrylate resin, a polyester resin, and a bio resin.

12. The productivity station of claim 1, wherein the workstation component further comprises multiple horizontal ribs below the top horizontal panel, the T-slot being positioned between two of the multiple ribs.

13. A productivity station, comprising:
a plurality of brackets configured to mount a workbench to a wall structural member;
the workbench to be mounted to the plurality of brackets, the workbench comprising:
a top horizontal panel;
multiple ribs below the top horizontal panel, the ribs comprising vertical ridges; and
a bottom-facing opening into an internal volume of the workbench forming a T-slot.

14. The productivity station of claim 13, further comprising at least one shelf to be mounted to a second plurality of brackets.

15. The productivity station of claim 13, further comprising:
a first upper shelf configured to be mounted above the workbench;
a second upper shelf configured to be mounted above the workbench; and
a lower shelf configured to be mounted below the workbench.

16. The productivity station of claim 13, further comprising an extension sleeve configured to secure two workbench or shelf components together.

17. The productivity station of claim 13, wherein the workbench further comprises a bottom horizontal panel.

18. The productivity station of claim 13, wherein the workbench further comprises a finished end.

19. The productivity station of claim 13, wherein at least one of the first upper shelf and the second upper shelf further comprises a finished end at an end of the at least one of the first upper shelf and the second upper shelf.

20. The productivity station of claim 13, wherein the workbench further comprises a selected and customized horizontal length.
